(19) United States
(12) Patent Application Publication
(10) Pub. No.: US 2023/0327323 A1
(43) Pub. Date: Oct. 12, 2023

(54) ELECTRONIC DEVICE COMPRISING AN ANTENNA

(71) Applicant: SAMSUNG ELECTRONICS CO., LTD., Suwon-si (KR)

(72) Inventors: Jongmin KIM, Suwon-si (KR); Sangho HONG, Suwon-si (KR); Hyoseok NA, Suwon-si (KR); Gunhee PARK, Suwon-si (KR); Yongam SON, Suwon-si (KR); Jongkwan LEE, Suwon-si (KR); Hanyeop LEE, Suwon-si (KR); Taihwan CHOI, Suwon-si (KR)

(21) Appl. No.: 18/210,975

(22) Filed: Jun. 16, 2023

Related U.S. Application Data
(63) Continuation of application No. PCT/KR2022/012734, filed on Aug. 25, 2022.

(30) Foreign Application Priority Data
Sep. 28, 2021 (KR) 2021-0128308

(51) Int. Cl. H01Q 1/24; H04N 23/57; H01Q 5/314

(52) U.S. Cl. CPC H01Q 1/243; H04N 23/57; H01Q 5/314

(57) ABSTRACT

An electronic device according to an embodiment may include a camera module, a metal structure, a first antenna adjacent to the camera module, a second antenna spaced from the camera module, a switching module electrically connected to the metal structure, including at least one lumped element, and adjusting an impedance by using the at least one lumped element, and at least one processor. The at least one processor is configured to transmit a signal in a first frequency band by feeding the first antenna and control the switching module such that the switching module has a first impedance corresponding to the first frequency band and electrically connects the metal structure and the ground when the transmission power of the first antenna is equal to or more than the designated value.

### CROSS-REFERENCE TO RELATED APPLICATIONS

This application is a continuation application, claiming priority under § 365(c), of an International application No. PCT/KR20221012734, filed on Aug. 25, 2022, which is based on and claims the benefit of a Korean patent application number 10-2021-0128308, filed on Sep. 28, 2021, in the Korean Intellectual Property Office, the disclosure of which is incorporated by reference herein in its entirety.

### BACKGROUND

### Field

The disclosure relates to an electronic device including an antenna.

### Description of Related Art

An electronic device (for example, a smartphone, a tablet personal computer or PC, or a wearable device) may provide various functions in addition to voice communication. For example, the electronic device may provide various functions such as short-range wireless communication (for example, Bluetooth, Wi-Fi, or near field communication (NEC)) function, a mobile communication (3G (generation), 4G, or 5G) function, a music or video playback function, a photographing function, or a navigation function.

### SUMMARY

An electronic device may include a camera module including at least one camera for providing an image capture function. In addition, the electronic device may include at least one antenna for proving various communication functions.

As electronic devices support 5G communication, the frequency band of the radio frequency (RE) supported by electronic devices has increased, and the number of antenna radiators has also increased. As an electronic device has limited interior space, antennas may be disposed adjacent to a camera module. In addition, an antenna supporting 5G may need to be able to receive signals and also to transmit a sounding reference signal (SRS) for optimal antenna efficiency.

Antennas are disposed adjacent to a camera module, adjacent antennas not only receive RF signals but also transmit RF signals in 5G communication environments, and a part of transmission power of the antennas may be induced to the cameras. The transmission power induced to the camera module may affect communication between the camera module and the processor inside the electronic device, and may inconvenience the user.

Various embodiments disclosed herein may include a metal structure coupled to a camera module and a switching module electrically connected to the ground. The switching module may be controlled to adjust impedance in response to the frequency band of RE signals transmitted by antennas adjacent to the camera module.

An electronic device according to an embodiment may include a camera module including at least one camera, a metal structure disposed on and coupled to the camera module so as to cover a portion of the camera module, a first antenna adjacent to the camera module and a second antenna spaced apart from the camera module, a switching module electrically connected to the metal structure and including at least one lumped element so as to adjust impedance by using the at least one lumped element, a ground electrically connected to the metal structure through the switching module, and at least one processor electrically connected to the first antenna, the second antenna, and the switching module. The at least one processor is configured to transmit a signal in a first frequency band by feeding the first antenna adjacent to the camera module, determine whether transmission power of the first antenna is equal to or more than a designated value when the first frequency band corresponds to a designated frequency band, and control the switching module such that the switching module has a first impedance corresponding to the first frequency band and electrically connects the metal structure and the ground when the transmission power of the first antenna is equal to or more than the designated value.

An electronic device according to an embodiment may include a frame configured to form at least a portion of an edge of the electronic device, a camera module disposed adjacent to the first corner and including at least one camera, a metal structure disposed on and coupled to the camera module so as to cover a portion of the camera module, a switching module electrically connected to the metal structure and including at least one lumped element so as to adjust impedance by using the at least one lumped element, a ground electrically connected to the metal structure through the switching module, and at least one processor electrically connected to the switching module. The edge of the electronic device formed by the frame includes a first edge extending toward a first direction and a second edge forming a first corner at one end of the first edge and extending in a second direction perpendicular to the first direction. The frame includes a first portion forming an area including the first corner. The at least one processor is configured to transmit a signal in a first frequency band by feeding the first portion of the frame, determine whether transmission power of the signal in the first frequency band is equal to or more than a designated value when the first frequency band corresponds to a designated frequency band, and control the switching module such that the switching module has a first impedance corresponding to the first frequency band and electrically connects the metal structure and the ground when the transmission power is equal to or more than the designated value.

According to various embodiments disclosed herein, an electronic device may reduce or prevent transmission power of an antenna adjacent to a camera module from being induced to the camera module and affecting communication between the camera module and the processor.

Various other advantageous effects identified explicitly or implicitly through the disclosure may be provided.

### BRIEF DESCRIPTION OF THE DRAWINGS

FIG. 1 is a diagram illustrating an electronic device in a network environment according to an embodiment.

FIG. 2A is a perspective view illustrating an electronic device according to an embodiment.

FIG. 2B is a perspective view illustrating a rear surface of the electronic device in FIG. 2A.

FIG. 3 is an exploded view of an electronic device according to an embodiment.

FIG. 4 is a view illustrating an operation in which a processor grounds a current induced to a metal structure to a ground by controlling a switching module according to an embodiment.

FIG. 5 is a view illustrating an operation of grounding a current induced on a metal structure to a ground by controlling a switching module including a variable capacitor according to an embodiment.

FIG. 6 is an equivalent circuit diagram of a switching module including a metal structure and a variable capacitor according to an embodiment.

FIG. 7 is a flowchart illustrating a concrete operation of controlling a switching module by a processor according to an embodiment.

FIG. 8 is a view illustrating an effect in a camera module according to presence or absence of a switching module or an impedance of a switching module when a signal in a designated frequency band is transmitted by feeding the camera module and an adjacent frame according to an embodiment.

FIG. 9A illustrates an S11 graph according to a change in capacitance of a variable capacitor included in a switching module according to an embodiment.

FIG. 9B illustrates an S11 graph according to a change in capacitance of a variable capacitor included in a switching module according to an embodiment.

FIG. 9C illustrates: an S11 graph according to an inductance value of a first inductor included in a switching module according to an embodiment.

FIG. 10 illustrates a switching module further including an inductor for ESD prevention according to an embodiment.

FIG. 11 illustrates a switch module according to an embodiment.

FIG. 12A is a flowchart illustrating an operation of controlling the switching module shown in FIG. 11 by a processor according to art embodiment.

FIG. 12B is a flowchart illustrating an operation of controlling the switching module shown in FIG. 11 by a processor according to an embodiment.

FIG. 13 illustrates a switching module electrically connected to a metal structure and a fifth antenna according to an embodiment.

FIG. 14 is a flowchart illustrating a concrete operation of controlling the switching module shown in FIG. 13 by a processor according to an embodiment.

FIG. 15A is a view illustrating an operation in which a processor performs impedance matching of a metal structure by controlling the first switch circuit shown in FIG. 13 according to an embodiment.

FIG. 15B is a flowchart illustrating an operation of controlling the switching module shown in FIG. 13 by a processor according to art embodiment.

FIG. 16 is a view illustrating an operation in which a processor performs impedance matching of a fifth antenna by using a second switch circuit according to an embodiment.

FIG. 17 is a concrete example illustrating an arrangement position of a switching module according to an embodiment.

FIG. 18 illustrates a metal structure electrically connected to a switching module according to various embodiments.

In connection with a description of the drawings, like or similar reference numerals may be used for like or similar elements.

### DETAILED DESCRIPTION

Hereinafter, various embodiments of the disclosure will be described with reference to the accompanying drawings. However, this is not intended to limit the disclosure to specific embodiments, and it should be understood that various modifications, equivalents, and/or alternatives of the embodiments of the disclosure are included.

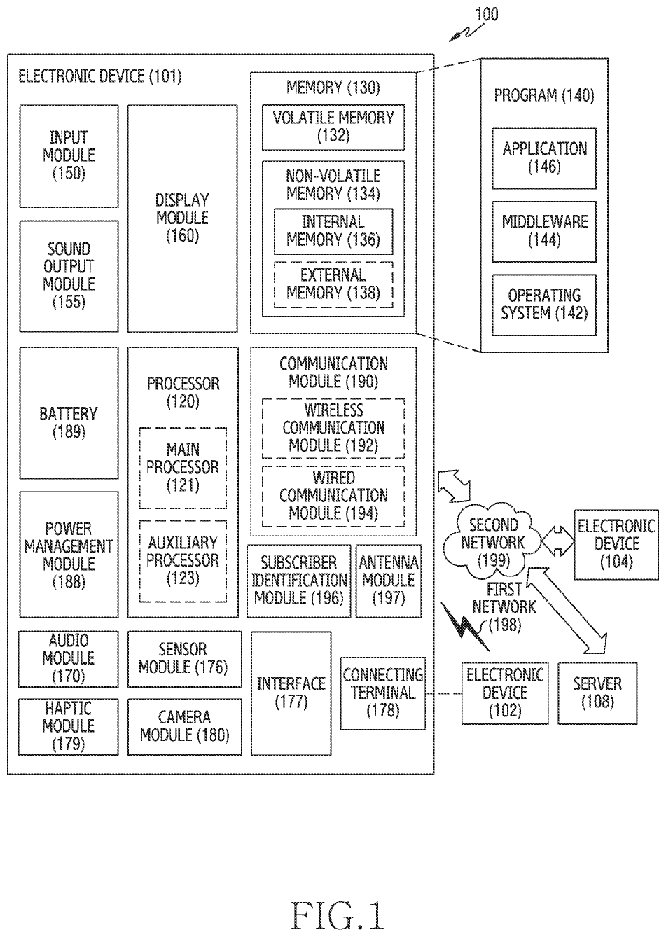

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 1_89, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may, be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DPN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102), According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 50 network, after a 40 network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of inns or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit hoard, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIDI)).

According to art embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server. According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

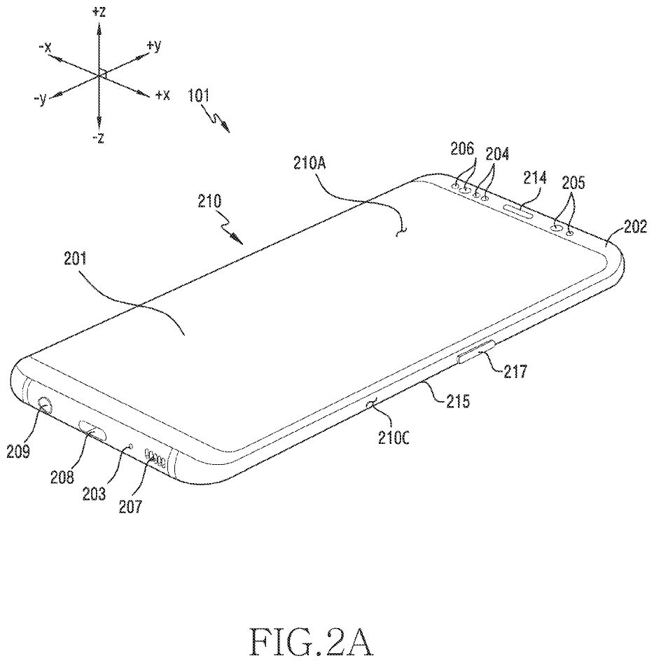

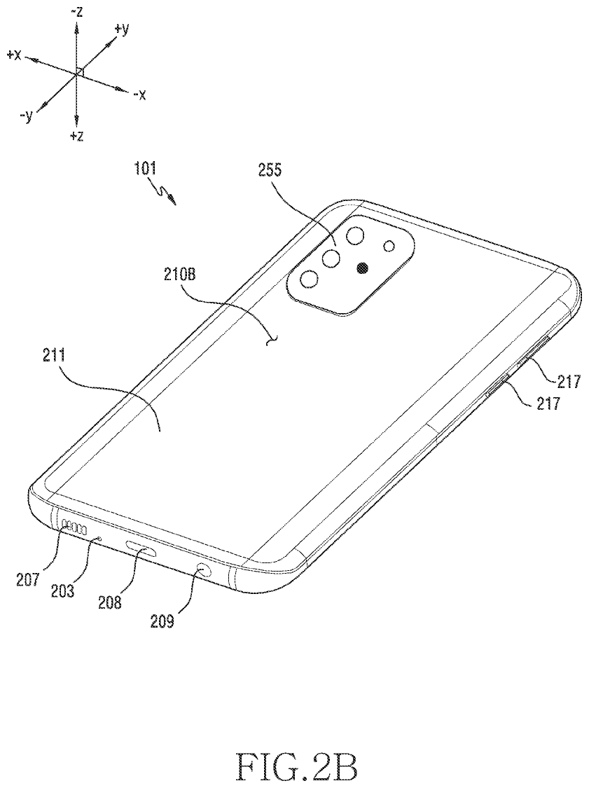

FIG. 2A is a perspective view illustrating an electronic device according to an embodiment.

FIG. 2B is a perspective view illustrating a rear surface of the electronic device in FIG. 2A.

Referring to FIG. 2A and FIG. 2B, the electronic device 101 according to an embodiment may include a housing 210 including a first surface (or front surface) 210A, a second surface (or rear surface) 210B, and a side or lateral surface 210C surrounding a space between the first surface 210A and the second surface 210B. According to another embodiment (not shown), the housing may refer to a structure for configuring a portion of the first surface 210A, the second surface 210B, and the lateral surface 210C in FIG. 2A and FIG. 2B.

According to an embodiment, at least a portion of the first surface 210A of the electronic device 101 may be formed of a substantially transparent front plate 202 (e.g., a glass plate including various coating layers or a polymer plate). In an embodiment, the front plate 202 may include a curved surface portion seamlessly extending on at least one side edge portion while bending from the first surface 210A toward a rear cover 211 (see FIG. 2).

According to an embodiment, the rear cover 211 may be substantially opaque and the second surface 210B may be formed of the substantially opaque rear cover 211. The rear cover 211 may be formed by, for example, coated or colored glass, ceramic, polymers, metals (for example, aluminum, stainless steel (STS), or magnesium), or a combination of at least two or more thereof. According to an embodiment, the rear cover 211 may include a curved surface portion seamlessly extending on at least one side edge portion while bending from the second surface 210B toward the front plate 202.

According to an embodiment, the lateral surface 210C of the electronic device 101 may be coupled to the front plate 202 and the rear cover 211 and may be formed by a frame 215 including a metal and/or polymer. In another embodiment, the rear cover 211 and the frame 215 may be integrally formed and may include substantially the same material (e.g., a metal material such as aluminum).

According to an embodiment, the electronic device 101 may include at least one of a display 201, an audio module 170, a sensor module 204, a first camera module 205, a key input device 217, a first connector hole 208, and a second connector hole 209. In another embodiment, the electronic device 101 may omit at least one component (e.g., the key input device 217) or additionally include another component. By way of example, a sensor such as a proximity sensor or illuminance sensor in an area provided by the front plate 202 may be integrated into the display 201 or disposed at a position adjacent to the display 201. In an embodiment, the electronic device 101 may further include a light-emitting element 206, and the light-emitting element 206 may be disposed at a position adjacent to the display 201 in an area provided by the front plate 202. The light-emitting element 206 may provide state information of the electronic device 101 in a form of light, for example. In still another embodiment, the light-emitting element 206 may provide, for example, a light source interlocking with an operation of the first camera module 205. The light-emitting element 206 may include, for example, a light emitting diode (LED), an infrared LED (IR LED), and a xenon lamp.

The display 201 may be exposed through, for example, a substantial portion of the front plate 202. In another embodiment, an edge of the display 201 may be configured to be roughly identical to a frame shape (e.g., a curved surface) adjacent to the front plate 202. In another embodiment, to expand an area of the display 201 to be exposed, a gap between a frame of the display 201 and a frame of the front plate 202 may be roughly constant or uniform. In another embodiment, the display 201 may include a recess or an opening formed on a portion of a screen display area, and may include another electronic component, arranged with the recess or the opening, for example, the camera module 205, a proximity sensor or an illuminance sensor (not shown).

According to an embodiment, the display 201 may be combined with or disposed adjacent to a touch sensing circuit, a pressure sensor for measuring a strength (pressure) of a touch, and/or a digitizer for detecting a magnetic field-type stylus pen.

In an embodiment, the audio module 170 may include a microphone hole 203, at least one speaker hole 207, and a receiver hole 214 for a call. A microphone for obtaining a sound from outside may be disposed in the microphone hole 203 and in an embodiment, multiple microphones may be arranged to detect a direction of a sound. In another embodiment, the at least one speaker hole 207 and the receiver hole 214 for a call may be implemented into one hole with the microphone hole 203 or a speaker may be included without a speaker hole 207 or the receiver hole 214 for a call (for example, a piezo speaker).

In an embodiment, the electronic device 101 may include the sensor module 204 and thus the electronic device 101 may generate an electrical signal or a data value corresponding to an internal operation state or corresponding to an external environmental state of the electronic device 101. The sensor module 204 may, further include, for example, a proximity sensor disposed on the first surface 210A of the housing 210, a fingerprint sensor integrated into or disposed adjacent to the display 201, and/or a biometric sensor (e.g., an FIRM sensor) disposed on the second surface 210B of the housing 210. The electronic device 101 may further include at least one sensor module not shown in the drawings, for example, a gesture sensor, a gyro sensor, an air pressure sensor, a magnetic sensor, an acceleration sensor, a grip sensor, a color sensor, an infrared (IR) sensor, a biometric sensor, a temperature sensor, a humidity sensor, or an illuminance sensor.

In an embodiment, the electronic device 101 may include a second camera module 255 disposed on the second surface 210B. The first camera module 255 and the second camera module 255 may include one or more of lenses, an image sensor, and/or an image signal processor. A flash (not shown) may be disposed on the second surface 210B. The flash may include, for example, a light-emitting diode or a xenon lamp. In another embodiment, two or more lenses (infrared camera, wide-angle, and telephoto lens) and image sensors may be arranged on a surface of the electronic device 101.

In an embodiment, the key input device 217 may be disposed on the lateral surface 2100 of the housing 210. According to another embodiment, the electronic device 101 may not include a portion or entirety of the key input device 21′7 described above, and the excluded key input device 217 may be effectively implemented in various alternative forms such as a soft key on the display 201. In another embodiment, the key input device 217 may include at least a portion of a fingerprint sensor disposed on the second surface 210B of the housing 210.

In an embodiment, the connector hole 208, 209 may include a first connector hole 208 capable of receiving a connector (for example, a USB connector) for transmitting or receiving power and/or data to or from an external electronic device, and/or a second connector hole (e.g., an earphone jack) 209 capable of receiving a connector for transmitting or receiving an audio signal to or from an external electronic device.

Although FIG. 2A and FIG. 2B illustrates that the electronic device 101 corresponds to a bar-type, this is only illustrative and the electronic device 101 may correspond to various types of devices. For example, the electronic device 101 may correspond to a foldable device, a slidable device, a wearable device (e.g., a smart watch and a wireless earphone), or a tablet PC. Therefore, the technical idea described herein is not limited to the bar-type device shown in FIG. 2A and FIG. 2B, and may be applied to various types of devices.

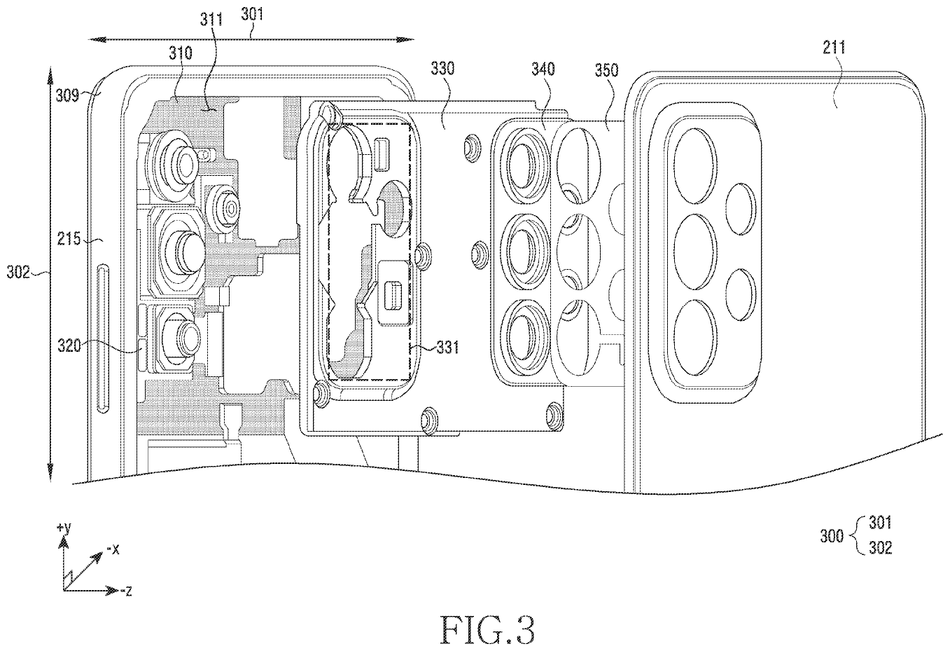

FIG. 3 is an exploded view of an electronic device according to an embodiment.

Referring to FIG. 3, the frame 215 according to an embodiment may form the edge 300 of electronic device 101. For example, the frame 215 may form a first edge 301 and a second edge 302. In an embodiment, the first edge 301 may extend in a first direction (e.g., the x-axis direction) and the second edge 302 may form a first corner 309 at one end of the first edge 301 and extend in a second direction (e.g., the y-axis direction) perpendicular to the first direction (e.g., the x-axis direction).

According to an embodiment, the electronic device 101 may include a printed circuit hoard (PCB) 310, a camera module 320, a support member 330, a metal structure 340, and/or a film 350.

According to an embodiment, various electronic components (e.g., the camera module 320, the processor 120, or the memory 130) may be arranged on the PCB 310. For example, the PCB 310 may include a first surface 311 facing the rear surface of the electronic device 101, and the camera module 3:20 may be disposed on the first surface 311. In an embodiment, the PCB 310 may include multiple conductive layers, and a ground for an antenna operation may be formed on a first layer of the multiple conductive layers. In an embodiment, the camera module 320 may include at least one camera. The camera module 320 may correspond to the second camera module 255 shown in FIG. 2B, and the description for the second camera module 255 described with reference to FIG. 2B may be applied to the camera module 320. In an embodiment, at least one camera of the camera module 320 may be disposed in a direction (e.g., the −z direction) facing the rear surface of the electronic device 101.

According to an embodiment, the support member 330 may be located in a third direction (e.g., the −z direction) with respect to the PCB 310. That is, the support member 330 may neighbor or may be adjacent to the PCB 310 in the −z direction. The support member 330 may fix components inside the electronic device 101. For example, the support member 330 may include a groove 331 into which the camera module 320 is inserted. In an embodiment, the camera module 320 may be inserted into and fixed to the groove 331 of the support member 330.

According to an embodiment, the metal structure 340 may be located in the third direction (e.g., the −z direction) with respect to the camera module 320. That is, the metal structure 340 may neighbor or may be adjacent to the support member 330 in the −z direction. The metal structure 340 may be coupled to the camera module 320 and may cover a portion of the camera module 320.

According to an embodiment, the film 350 may be disposed between the metal structure 340 and the rear cover 211. In an embodiment, the film 350 may correspond to a black matrix, and the film 350 may block light incident to the film 350.

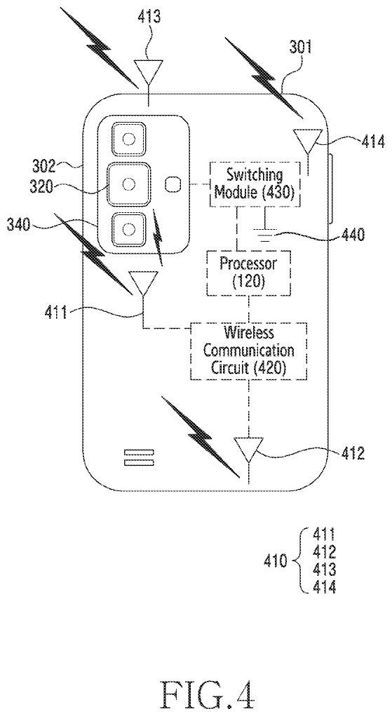

FIG. 4 is a view illustrating an operation in which a processor grounds a current induced to a metal structure to a ground by controlling a switching module according to an embodiment.

Referring to FIG. 4, the electronic device 101 according to an embodiment may include antennas 410 for wireless communication. For example, the electronic device 101 may include a first antenna 411, a second antenna 412, a third antenna 413, and/or a fourth antenna 414. In an embodiment, the first antenna 411 and the third antenna 413 may correspond to an antenna adjacent to the camera module 320. The second antenna 412 and the fourth antenna 414 may correspond to an antenna spaced a designated distance or more apart from the camera module 320. In an embodiment, the antennas 410 may transmit and/or receive an RF signal in various frequency bands. For example, the antennas 410 may transmit and/or receive a signal in a frequency band of 7.125 GHz or lower. For another example, the antennas 410 may transmit and/or receive a signal in a frequency band of 7.125 GHz or higher to support 5G communication. In an embodiment, a signal transmitted by the antennas 410 may correspond to a sounding reference signal (SRS) for measuring quality of a wireless communication channel. For another example, the antennas 410 may support 2G, 3G, and/or 4G (long-term evolution) communication. For another example, the antennas 410 may support global positioning system (GPS) communication and/or Wi-Fi communication.

According to an embodiment, the antennas 410 may have various shapes and types. For example, each of the antennas 410 may correspond to patch antennas having various arrays (e.g., 1×2, 2×2, 1×4, or 1×5 antenna array). For another 2.5 example, the antennas 410 may correspond to an inverted-F antenna (IFA) using a conductive portion of the frame 215. The shapes and types of the antennas 410 are limited to the above-described example and the antennas may correspond to a slot antenna (or slit antenna), a monopole antenna and/or a dipole antenna.

According to an embodiment, the electronic device 101 may include a wireless communication circuit 420, and the wireless communication circuit 420 may, be electrically connected to the antennas 410. For example, the wireless communication circuit 420 may be electrically connected to the first antenna 411, the second antenna 412, the third antenna 413, and/or the fourth antenna 414. The wireless communication circuit 420 may feed the antennas 410 to transmit and/or receive a signal in a designated frequency band.

According to an embodiment, the electronic device 101 may include a switching module 430, and the switching module 430 may include at least one lumped element (e.g., an inductor or a capacitor). The switching module 430 may adjust an impedance using at least one lumped element. In an embodiment, the switching module 430 may be electrically connected to a ground 440. The ground 440 may be formed on a PCB (e.g., the PCB 310 in FIG. 3) as described above with reference to FIG. 3, and may be formed on various conductive structures (e.g., a flexible printed circuit board (FPCB)) inside the electronic device 101.

According to an embodiment, the processor 120 may be electrically connected to the camera module 320, the wireless communication circuit 420, and/or the switching module 430. The processor 120 may control the wireless communication circuit 420 and feed the first antenna 411 adjacent to the camera module 320 to transmit an RE signal in a first frequency band. A portion of transmission power of the first antenna 411 may be induced on the metal structure 340 coupled to the camera module 320. In an embodiment, the processor 120 may control the switching module 430 such that the switching module 430 has a first impedance corresponding to the first frequency band and connects the metal structure 340 and the ground 440. As such, transmission power induced on the metal structure 340 may be grounded to the ground 440 through the switching module 430. The processor 120 of the disclosure may substantially correspond to at least one processor. For example, the processor 120 may include a plurality of processors (e.g., application processor, communication processor, and/or power management processor). For example, the processor 120 may include one processor (e.g., application processor or communication processor).

According to an embodiment, the electronic device 101 may prevent the transmission power induced on the first antenna 411 from interfering with communications between the camera module 320 and the processor 120 by allowing the switching module 430 to have a first impedance corresponding to the first frequency band and to electrically connect the metal structure 340 and the ground 440.

For example, the camera module 320 including at least one camera may obtain an image, and the obtained image may be transmitted to the processor 120. In case that the electronic device 101 does not include the switching module 430, transmission power induced on the first antenna 411 may affect communication between the processor 120 and the camera module 320. On the contrary, as the switching module 430 electrically connected to the ground 440 according to an embodiment may be electrically connected to the metal structure 340 with the first impedance corresponding to the first frequency band, transmission power induced on the first antenna 411 may be grounded to the ground 440. Therefore, as grounded to the ground 440, induced transmission power may be reduced in strength and thus not affect communications between the processor 120 and the camera module 320. The first impedance corresponding to the first frequency band may mean an impedance configured to allow a first frequency band signal to be easily grounded to the ground 440.

As a result, the electronic device 101 may prevent induced transmission power from affecting communications between the processor 120 and the camera module 320 to prevent a photographing screen displayed on the display 201 when an external object is photographed by using the camera module 320 from being shaken and to prevent a low-quality image due to screen shaking from being stored in the memory 130.

The description of grounding induced transmission power from the first antenna 411 adjacent to the camera module 320 to the ground 440 through the switching module 430 with reference to FIG. 4 may be applied substantially identically to the third antenna 413 adjacent to the camera module 320. For example, by controlling of the processor 120 and/or the wireless communication circuit 420, the switching module 430 may have a second impedance corresponding to a second frequency band to be transmitted and/or received by the third antenna 413 and electrically connect the metal structure 340 and the ground 440.

The embodiment of FIG. 4 illustrates the processor 120 and the wireless communication circuit 420 separately, but the embodiment separates the processor 120 including a communication processor (CP) and an application processor (AP), and the wireless communication circuit 420 corresponding to a transceiver for convenience of explanation. In an embodiment, the processor 120 may include an AP and the wireless communication circuit 420 may include a CP. In an embodiment, the processor 120 may include a CP, and the wireless communication circuit 420 may correspond to a transceiver. As a result, in a description in which the processor 120 disclosed herein adjusts an impedance of the switching module 430 in response to a frequency band transmitted by the first antenna 411 and/or the third antenna 413 adjacent to the camera module 320, the processor 120 may be understood to include an application processor (AP) and/or a communication processor (CT).

In addition, although the embodiment of FIG. 4 illustrates the processor 120 and the wireless communication circuit 420 as separate configurations, this is for convenience of explanation, and in an embodiment, the processor 120 and the wireless communication circuit 420 may be described as a concept of one wireless communication circuit.

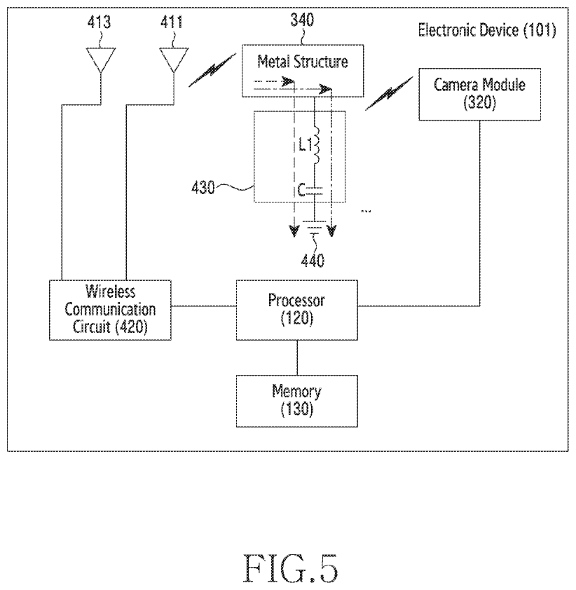

FIG. 5 is a view illustrating an operation of grounding a current induced on a metal structure to a ground by controlling a switching module including a variable capacitor according to an embodiment.

Referring to FIG. 5, the switching module 430 according to an embodiment may include at least one lumped element. For example, the switching module 430 may include a first inductor L1 and/or a variable capacitor C.

According to an embodiment, the processor 120 may control the wireless communication circuit 420 such that a signal in a designated frequency band is transmitted by the first antenna 411 and/or the third antenna 413 through the camera module 320. For example, the processor 120 may control the wireless communication circuit 420 such that a signal in a first frequency band is transmitted through the first antenna 411 adjacent to the camera module 320. For another example, the processor 120 may control the wireless communication circuit 420 such that a signal in a second frequency band is transmitted through the third antenna 413 adjacent to the camera module 320.

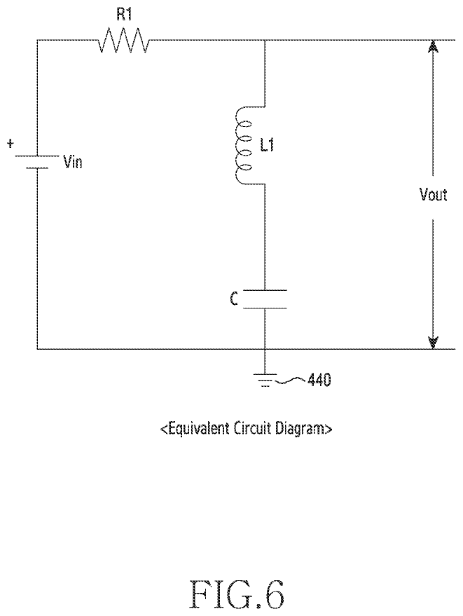

According to an embodiment, the processor 120 may control the switching module 430 such that the switching module 430 has an impedance corresponding to a frequency band of an RF signal being transmitted and electrically connects the metal structure 340 and the ground 440. For example, when an RF signal in a first frequency band is transmitted through the first antenna 411, the processor 120 may control a capacitance of the variable capacitor C to provide a first capacitance such that the switching module 430 has a first impedance corresponding to the first frequency band. For another example, when an RF signal in a second frequency band is transmitted through the third antenna 413, the processor 120 may control a capacitance of the variable capacitor C to provide a second capacitance such that the switching module 430 has a second impedance corresponding to the second frequency band. As described below with reference to FIG. 6, the switching module 430 may serve as or perform a function of a notch filter, and signals corresponding to frequency bands transmitted by the first antenna 411 and/or the third antenna 413 may be transferred to the ground 440.

According to an embodiment, the memory 130 may store information related to an impedance corresponding to frequency bands transmitted by antennas adjacent to the camera module 320. For example, the memory 130 may store information related to a first impedance corresponding to a first frequency band of the first antenna 411. For another example, the memory 130 may store information related to a second impedance corresponding to a second frequency band of the third antenna 413. In an embodiment, the processor 120 may be electrically connected to the memory 130, and the processor 120 may obtain information on impedances corresponding to the frequency bands from the memory 130. The processor 120 may control the switching module 430 based on the obtained information on the impedances. In an embodiment, the impedance corresponding to frequency bands transmitted by antennas may mean an impedance maximizing a signal transferred to the ground 440 in a signal in a designated frequency band that is induced to the metal structure 340. For example, when the first antenna 411 transmits and/or receives a first signal in a first frequency band and a first RF signal in a first frequency band is induced to the metal structure 340, a first impedance corresponding to a first frequency band may mean an impedance maximizing a signal transferred to the ground 440 in a first RF signal in a first frequency band induced to the metal structure 340.

FIG. 6 is an equivalent circuit diagram of a switching module including a metal structure and a variable capacitor according to an embodiment.

FIG. 6 illustrates an equivalent circuit diagram of the metal structure 340 and the switching module 430 shown in FIG. 5 according to an embodiment. A first resistance R1 may correspond to the metal structure 340 and may correspond to the first inductor L1 and the variable capacitor C of the switching module 430 shown in FIG. 5.

According to an embodiment, the first inductor L1 and the variable capacitor C of the switching module 430 may form a band stop filter or a notch filter. As used herein, the term “notch filter” may refer to a type of filter that removes or reduces an input signal in a designated frequency band and passes a frequency band lower or higher than the designated frequency band. The relationship among a center frequency (or notch frequency) ω, a first inductance of the first inductor L1, and a first capacitance of the variable capacitor C is shown in Equation 1.

$$ω = \frac{1}{\sqrt{( first inductance ) ( first capacitance )}} \qquad [ Equation 1 ]$$

Accordingly, when an output voltage Vout is measured with respect to an input voltage Yin that is applied to the first resistance R1 corresponding to the metal structure 340, a signal in a designated frequency band (e.g., the first frequency band and the second frequency band) and/or a signal in a multiplied frequency (harmonic) of a designated frequency band may be blocked. As used herein, the term “first frequency band” may refer to a frequency band of a signal transmitted and/or received by the first antenna 411 adjacent to the camera module 320. As used herein, the term “second frequency band” may refer to a frequency band of a signal transmitted and/or received by the second antenna 412 adjacent to the camera module 320.

In an embodiment, the input voltage Vin may correspond to an induced power of transmission power of antennas (e.g., the first antenna 411) adjacent to the camera module 320, and the output voltage Vout may correspond to a voltage of the camera module 320. As a result, based on the above-described principle, by forming a band stop filter that is configured to block a signal in a frequency band of antennas adjacent to the camera module 320, the electronic device 101 may reduce or prevent a signal in a designated frequency band from affecting communication between the camera module 320 and the processor 120 through the metal structure 340.

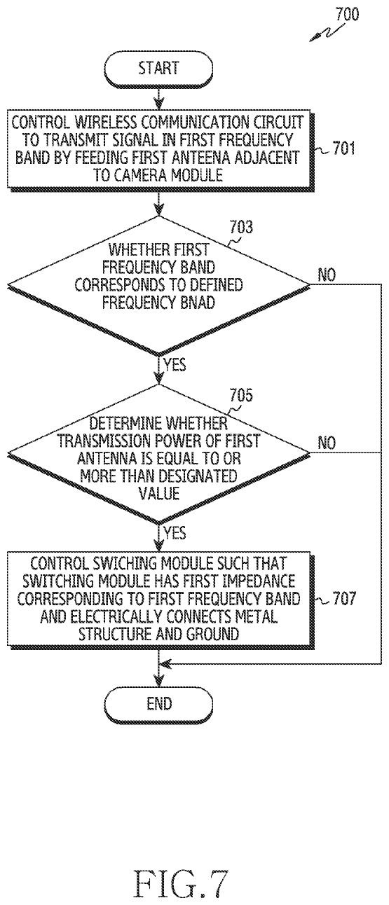

FIG. 7 is a flowchart illustrating an operation of controlling a switching module by a processor according to an embodiment.

Referring to FIG. 7, the processor 120 according to an embodiment may control the wireless communication circuit 420 and feed the first antenna 411 adjacent to the camera module 320 to transmit a signal in a first frequency band in operation 701.

According to an embodiment, the processor 120 may determine whether the first frequency band corresponds to a defined frequency band in operation 703. For example, the memory 130 may store information on the defined frequency band. As used herein, the term “defined frequency band” may refer to a frequency band of an RE signal transmitted and/or received by antennas (e.g., the first antenna 411) adjacent to the camera module 320. In an embodiment, the processor 120 may obtain information on the defined frequency band from the memory 130, and determine whether the first frequency band of the first antenna 411 corresponds to the defined frequency band based on the information.

According to an embodiment, when the first frequency band corresponds to the defined frequency band, the processor 120 may determine whether transmission power of the first antenna 411 is equal to or more than a designated value in operation 705. The designated value may be configured based on whether to affect communication between the camera module 320 and the processor 120.

According to an embodiment, when transmission power of the first antenna 411 is equal to or more than the designated value, the processor 120 may control the switching module 430 such that the switching module 430 has a first impedance corresponding to the first frequency band and electrically connects the metal structure 340 and the ground 440 in operation 707. In an embodiment, power induced to the metal structure 340 of the transmission power of the first antenna 411 having the designated value may be grounded to the ground 440, and according thereto, the camera module 320 and the processor 120 may be not affected by the induced power.

The flowchart 700 shown in Fla 7 is illustrated based on the first antenna 411 adjacent to the camera module 320. However, the flowchart is merely an illustrative example, is not limited to the first antenna 411, and may be applied to antennas (e.g., the third antenna 413) adjacent to the camera module 320. For example, the processor 120 may transmit a signal in a second frequency band by feeding the third antenna 413, determine whether transmission power of the third antenna 413 is equal to or more than a designated value when the second frequency band corresponds to a defined frequency band, and control a switching module such that the switching module connected to the third antenna 413 has a second impedance corresponding to the second frequency and electrically connects the metal structure 340 and the ground 440 when the transmission power is equal to or more than the designated value. The switching module electrically connected to the third antenna 413 may correspond to the switching module 430 shown in FIG. 4 or another switching module,

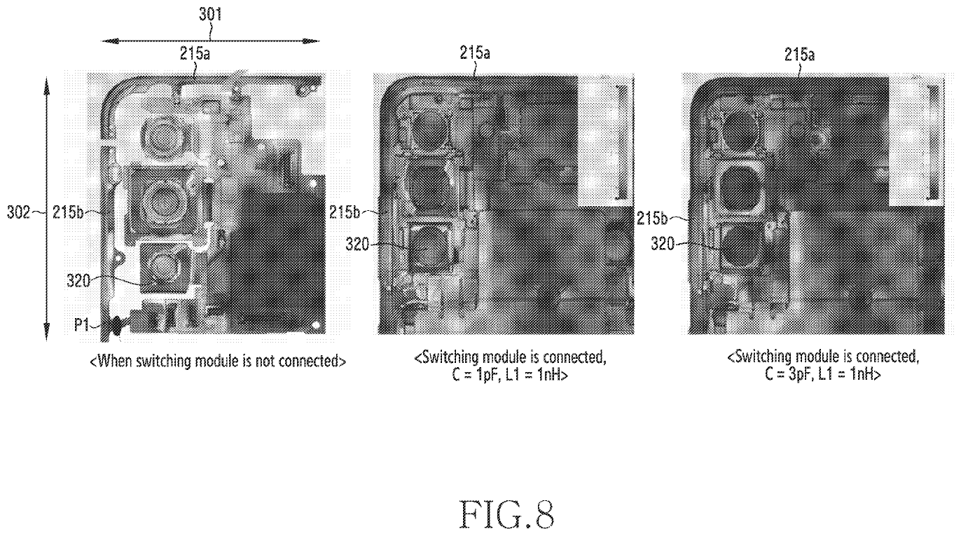

FIG. 8 is a view illustrating an effect in a camera module according to presence or absence of a switching module or impedance of a switching module when a signal in a designated frequency band is transmitted by feeding the camera module and an adjacent frame according to an embodiment.

Referring to FIG. 8, the frame 215 according to an embodiment may include a first portion 215a configured to form a first edge 301, and a second portion 215b configured to form a second edge 302. According to an embodiment, the wireless communication circuit 420 may feed a first point P1 of the second portion 215b of the frame 215 to transmit and/or receive a signal in a designated frequency band (e.g., a first frequency band).

When the switching module 430 is not electrically connected to the metal structure 340, an induced current may be formed on the camera module 320 by feeding the first point P1 of the second portion 215b by the wireless communication circuit 420. The induced current may interfere with communications between the camera module 320 and the processor 120.

On the contrary, when the switching module 430 according to an embodiment is electrically connected to the metal structure 340, an induced current formed on the camera module 320 by feeding the first point P1 of the second portion 215b by the wireless communication circuit 420 may be relatively small compared to when the switching 430 is not connected. For example, when the variable capacitor C of the switching module 430 has a first capacitance (e.g., 1 pF) and the first inductor L1 has a first inductance (e.g., 1 nH), a relatively small, induced current may occur on the camera module 320 compared to when the switching module 430 is not connected. For another example, when the variable capacitor C of the switching module 430 has a second capacitance (e.g., 3 pF) and the first inductor L1 has a first inductance (e.g., 1 nH), a relatively small, induced current may occur on the camera module 320 compared to when the switching module 430 is not connected.

Accordingly, the electronic device 101 may reduce an induced current occurring on the camera module 320 by controlling the switching module 430 to have a first impedance corresponding to the first frequency band and to electrically connect the metal structure 340 and the ground 440. As a result, the electronic device 101 may prevent communication between the camera module 320 and the processor 120 from being disturbed by an induced current.

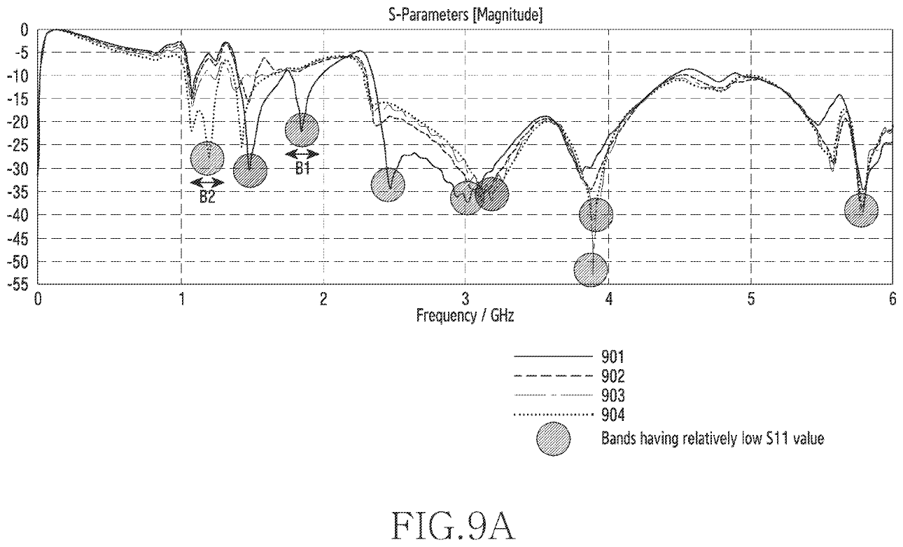

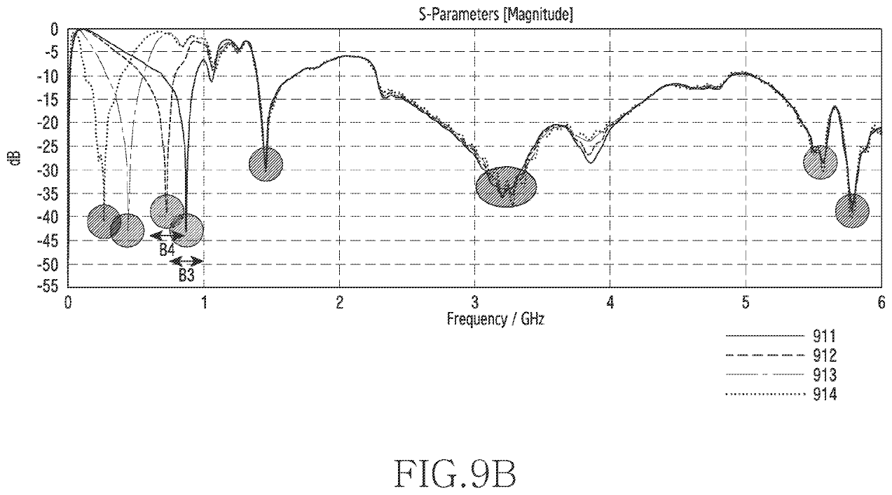

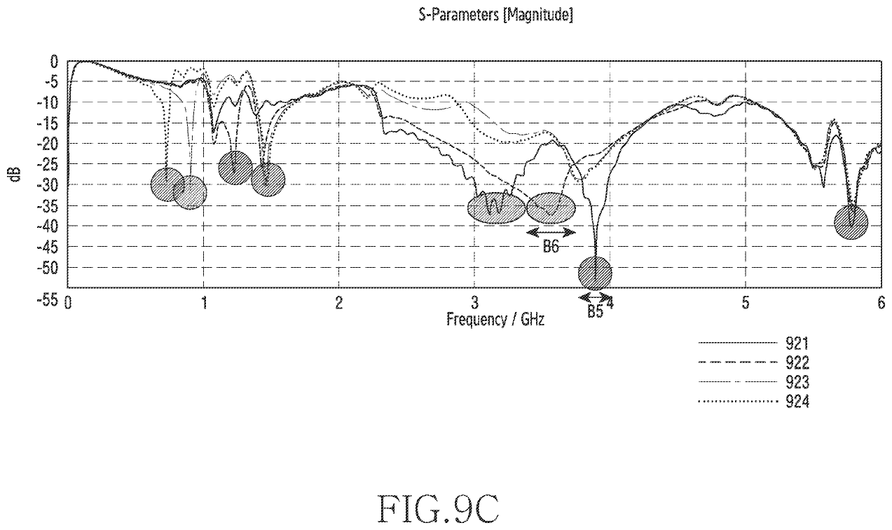

FIG. 9A illustrates an S11 graph according to a change in capacitance of a variable capacitor included in a switching module according to an embodiment.

Referring to FIG. 9A, a first graph 901 according to an embodiment may correspond to an S11 graph when the variable capacitor C of the switching module 430 has a first capacitance (e.g., 1 pF). A second graph 902 may correspond to an S11 graph when the variable capacitor C of the switching module 430 has a second capacitance (e.g., 2 pF). A third graph 903 may correspond to an S11 graph when the variable capacitor C of the switching module 430 has a third capacitance (e.g., 3 pF). A fourth graph 904 may correspond to an S11 graph when the variable capacitor C of the switching module 430 has a fourth capacitance (e.g., 4 pF).

According to an embodiment, the first graph 901, the second graph 902, the third graph 903, and the fourth graph 904 may include bands B having a relatively low S11 value. In an embodiment, a signal induced to the metal structure 340 among signals corresponding to bands B having a relatively low S11 value may be grounded to the ground 440 through the switching module 430. The bands B having a relatively low S11 value may be referred to a cutoff frequency band.

According to an embodiment, the electronic device 101 may control an impedance of the switching module 430 by controlling a capacitance value of the variable capacitor C of the switching module 430. As such, the electronic device 101 may secure a cutoff frequency band in various frequency hands. For example, referring to the first graph 901, as the variable capacitor C of the switching module 430 has a first capacitance (e.g., 1 pF), the electronic device 101 may secure a cutoff frequency band in a first frequency band B1. For another example, referring to the fourth graph 904, as the variable capacitor C of the switching module 430 has a fourth capacitance (e.g., 4 pF), the electronic device 101 may secure a cutoff frequency band in a second frequency band 32.

As a result, as the electronic device 101 adjusts an impedance of the switching module 430 in response to a designated frequency band transmitted by antennas adjacent to the camera module 320, a signal in the designated frequency band may be grounded to the ground 440 without being induced to the camera module 320.

FIG. 9B illustrates an Sit graph according to a change in capacitance of a variable capacitor included in a switching module according to an embodiment.

Referring to FIG. 93, a first graph 911 according to an embodiment may 2C correspond to an S11 graph when the variable capacitor C of the switching module 430 has a first capacitance (e.g., 0.2 ph). A second graph 912 may correspond to an S11 graph when the variable capacitor C of the switching module 430 has a second capacitance (e.g., 12 pF). A third graph 913 may correspond to an S11 graph when the variable capacitor C of the switching module 430 has a third capacitance (e.g., 33 pF). A fourth graph 914 may correspond to an S11 graph when the variable capacitor C of the switching module 430 has a fourth capacitance (e.g., 100 pF).

According to an embodiment, the electronic device 101 may control an impedance of the switching module 430 by controlling a capacitance value of the variable capacitor C of the switching module 430. As such, the electronic device 101 may secure a cutoff frequency band in various frequency bands. For example, referring to the first graph 911, as the variable capacitor C of the switching module 430 has a first capacitance (e.g., 0.2 pF), the electronic device 101 may secure a cutoff frequency band in a third frequency band B3. For another example, referring to the second graph 912, as the variable capacitor C of the switching module 430 has a second capacitance (e.g., 12 pF), the electronic device 101 may secure a cutoff frequency band in a fourth frequency band B4.

As a result, like the embodiment of FIG. 9A, the embodiment of FIG. 9B indicates that the electronic device 101 may secure a cutoff frequency band of various frequency bands according to a change in a capacitance value of the variable capacitor C of the switching module 430.

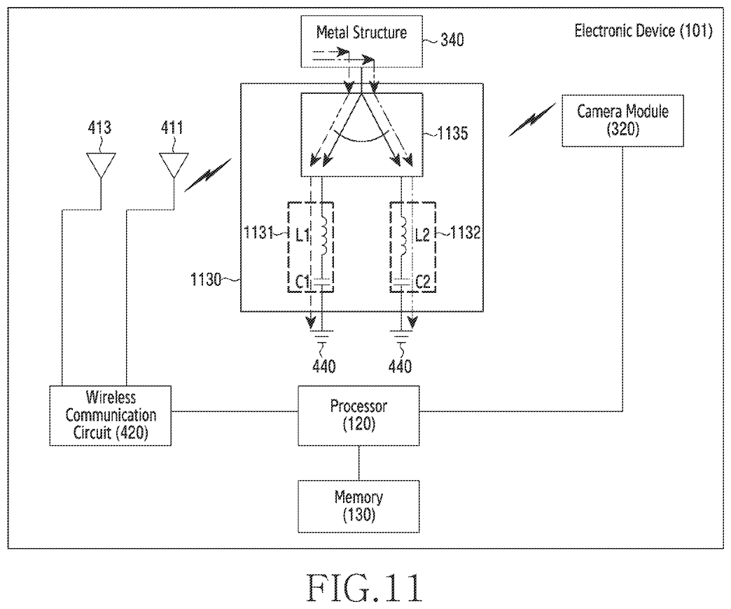

In FIG. 9A and FIG. 9B, an impedance change of the switching module 430 is explained based on the variable capacitor C shown in FIG. 5, but this is merely an illustrative example, and the impedance of the switching module 430 may be changed through various methods in practice. For example, referring to FIG. 11 to be described below, and impedance of the switching module 430 may be changed based on electrical connection relationship between lumped elements using a switch circuit. For another example, an impedance of the switching module 430 may be changed by an inductance value of an inductor included in the switching module 430 as will be described below with reference to FIG. 9C,

FIG. 9C illustrates an S11 graph according to an inductance value of a first inductor included in a switching module according to an embodiment.

Referring to FIG. 9C, a first graph 921 according to an embodiment may correspond to an S11 graph when the first inductor L1 of the switching module 430 has a first inductance (e.g., 1 nH). A second graph 922 may correspond to an S11 graph when the first inductor L1 of the switching module 430 has a second inductance (e.g., 2.2 nH). A third graph 923 may correspond to an S11 graph when the first inductor L1 of the switching module 430 has a third inductance (e.g., 6.8 nH). A fourth graph 924 may correspond to an S11 graph when the first inductor L1 of the switching module 430 has a fourth inductance (e.g., 12 nH).

According to an embodiment, the electronic device 101 may secure a cutoff frequency band in various frequency bands according to an inductance value of the first inductor L1 of the switching module 430. For example, referring to the first graph 921, as the first inductor L1 of the switching module 430 has a first inductance (e.g., 1 nH), the electronic device 101 may secure a cutoff frequency band in a fifth frequency band B5. For another example, referring to the second graph 922, as the first inductor L1 of the switching module 430 has a second inductance (e.g., 2.2 nH), the electronic device 101 may secure a cutoff frequency hand in a sixth frequency band B6.

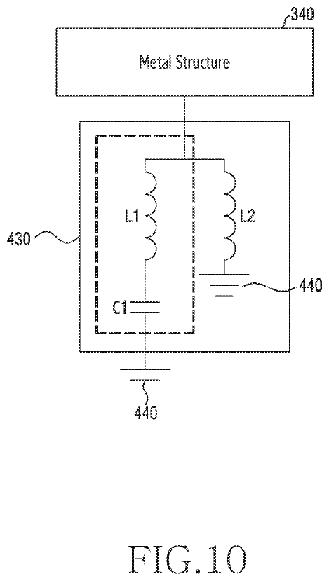

FIG. 10 illustrates a switching module further including an inductor for ESD prevention according to an embodiment.

Referring to FIG. 10, the switching module 430 according to an embodiment may further include a second inductor L2 for prevention of electrostatic discharge (ESD). The second inductor L2 may be electrically connected to the metal structure 340 and the ground 440. In an embodiment, the second inductor L2 may prevent ESD caused by various electronic components inside the electronic device 101 from affecting the camera module 320. The effect on the camera module 320 may be referred to as damage to the camera module 320 and/or degradation of an image obtained through the camera module 320.

FIG. 11 illustrates a switch module according to an embodiment.

Referring to FIG. 11, the electronic device 101 according to an embodiment may include a switching module 1130 including at least one lumped element. In an embodiment, the switching module 1130 may include a first lumped element group 1131 and/or a second lumped element group 1132 electrically connected to the ground 440. For example, the first lumped element group 1131 may include a first inductor L1 and/or a first capacitor C1. For another example, the second lumped element group 1132 may include a second inductor L2 and/or a second capacitor C2.

According to an embodiment, the first lumped element group 1131 and/or the second lumped element group 1132 may be electrically connected to the ground 440.

According to an embodiment, the switching module 1130 may include a switch circuit 1135. The switch circuit 1135 may be electrically connected to the metal structure 340. The switch circuit 1135 may include or correspond to various switches. For example, the switch circuit 1135 may include a single pole double through (SPDT) switch.

According to an embodiment, the processor 120 may control the switching module 1130 such that the switching module 1130 has an impedance corresponding to a frequency band of an RF signal being transmitted by antenna adjacent to the camera module 320 and electrically connects the metal structure 340 and the ground 440. For example, when an RF signal in a first frequency band is transmitted through the first antenna 411, the processor 120 may control the switch circuit 1135 such that the metal structure 340 is electrically connected to the ground 440 through the first lumped element group 1131. In this case, the first lumped element group 1131 of the switching module 1130 may have a first impedance corresponding to a first frequency band transmitted and/or received by the first antenna 411. For another example, when an RF signal in a second frequency band is transmitted through the second antenna 412, the processor 120 may control the switch circuit 1135 such that the metal structure 340 is electrically connected to the ground 440 through the second lumped element group 1132. In this case, the second lumped element group 1132 of the switching module 1130 may have a second impedance corresponding to a second frequency band transmitted and/or received by the second antenna 412.

According to an embodiment, the memory 130 may store information related to an impedance corresponding to frequency bands (e.g., the first frequency band and the second frequency band) transmitted by antennas adjacent to the camera module 320. In an embodiment, the processor 120 may be electrically connected to the memory 130, and the processor 120 may obtain information on impedances corresponding to the frequency bands from the memory 130. The processor 120 may control the switching module 430 based on the obtained information on the impedances.

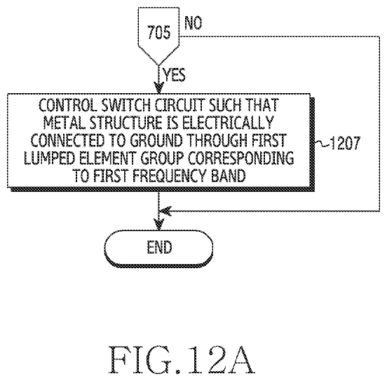

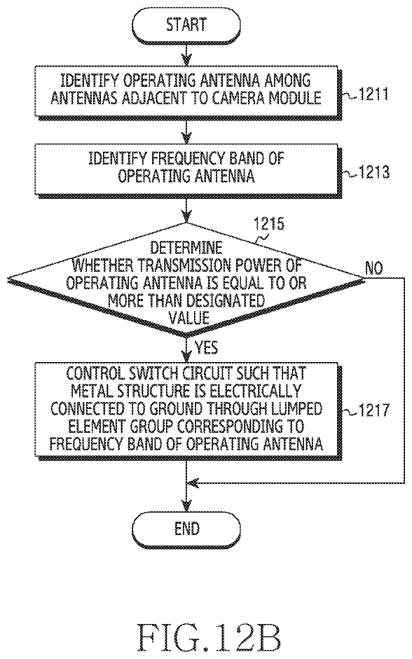

FIG. 12A is a flowchart illustrating an operation of controlling the switching module shown in FIG. 11 by a processor according to an embodiment.

Referring to FIG. 12A, the processor 120 according to an embodiment may determine whether transmission power of the first antenna 411 is equal to or more than a designated value in operation 705.

According to an embodiment, in operation 1207, when transmission power of the first antenna 411 is equal to or more than a designated value, the processor 120 may control the switch circuit 1135 such that the metal structure 340 is electrically connected to the ground 440 through the first lumped element group 1131 corresponding to a first frequency band.

Although described with reference to the first antenna 411 in FIG. 12A, the flowcharts illustrated in FIG. 12A may be applied substantially identically to antennas (e.g., the third antenna 413) adjacent to the camera module 320.

FIG. 12B is a flowchart illustrating an operation of controlling the switching module shown in FIG. 11 by a processor according to an embodiment.

Referring to FIG. 12B, the processor 120 according to an embodiment may identify an operating antenna among antennas (e.g., the first antenna 411 and the third antenna 413) adjacent to the camera module 320 in operation 1211. As used herein, the term “operating antenna” may be referred to as an antenna transmitting and/or receiving an RF signal to and/or from an external device.

According to an embodiment, the processor 120 may identify a frequency band of the operating antenna in operation 1213. For example, when the first antenna 411 is transmitting and/or receiving an RE signal to and/or from an external device, the processor 120 may identify a first frequency band which is a frequency band of the first antenna 411. For another example, when the second antenna 412 is transmitting and/or receiving an RE signal to and/or from an external device, the processor 120 may identify a second frequency band which is a frequency band of the second antenna 412.

Referring to FIG. 12A, the processor 120 may determine whether transmission power of an operating antenna is equal to or more than a designated value in operation 1215. For example, when the first antenna 411 is operating, the processor 120 may determine whether power to transmit a first RF signal in a first frequency band is equal to or more than a designated value. For another example, when the second antenna 412 is operating, the processor 120 may determine whether power to transmit a second RE signal in a second frequency band is equal to or more than a designated value.

According to an embodiment, in operation 1217, when transmission power of an operating antenna is equal to or more than a designated value, the processor 120 may control the switch circuit 1135 such that the metal structure 340 is electrically connected to the ground 440 through a lumped element group corresponding to a frequency band of the operating antenna. For example, the processor 120 may control the switch circuit 1135 such that the metal structure 340 and the ground 440 are electrically connected through the first lumped element group 1131 corresponding to the first frequency band. For another example, the processor 120 may control the switch circuit 1135 such that the metal structure 340 and the ground are electrically connected through the second lumped element group 1132 corresponding to the second frequency band.

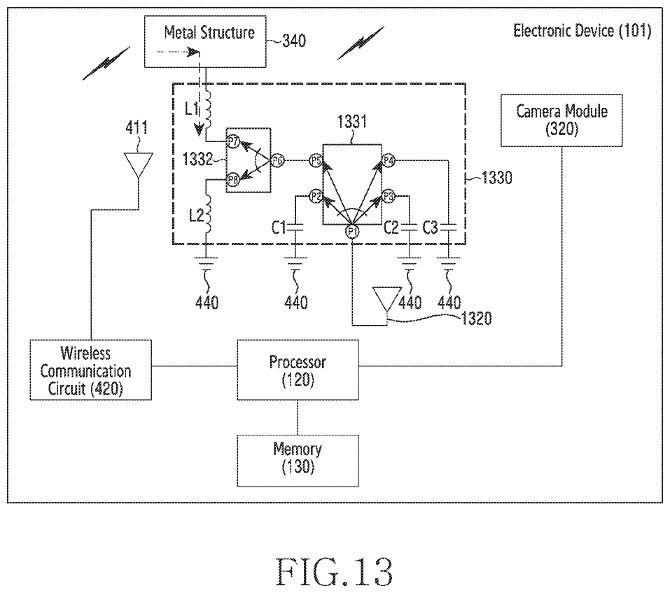

FIG. 13 illustrates a switching module electrically connected to a metal structure and a fifth antenna according to an embodiment.

Referring to FIG. 13, the electronic device 101 according to an embodiment may include the fifth antennas 1320. The wireless communication circuit 420 may be connected to the fifth antenna 1320 and may feed the fifth antenna 1320 to receive a signal in a designated frequency band. For example, the fifth antenna 1320 may correspond to an antenna configured to receive an RE signal from an external device.

According to an embodiment, the switching module 1330 may include a first switch circuit 1331 and a second switch circuit 1332. In an embodiment, the first switching module 1331 may be electrically connected to the fifth antenna 1320. For example, the first switch circuit 1331 may include a first port P1 electrically connected to the fifth antenna 1320, a second port P2 electrically connected to the first capacitor C1, a third port P3 electrically connected to the second capacitor C2, a fourth port. P4 electrically connected to a third capacitor C3, and/or a fifth port P5 electrically connected to the second switch circuit 1332.

According to an embodiment, the first switch circuit 1331 may be electrically connected to the metal structure 340 or the ground 440 through the second switch circuit 1332. For example, the second switch circuit 1332 may include a sixth port P6 electrically connected to the first switch circuit 1331, a seventh port P7 electrically connected to the metal structure 340 through the first inductor L1, and/or an eighth port P8 electrically connected to the ground 440 through the second inductor L2. In an embodiment, when the sixth port P6 and the seventh port P7 of the second switch circuit 1332 are electrically connected, the first switch circuit 1331 may be electrically connected to the metal structure 340 through the first inductor L1. In addition, when the sixth port P6 and the eighth port P8 of the second switch circuit 1332 are electrically connected, the first switch circuit 1331 may be electrically connected to the ground 440 through the second inductor L2.

According to an embodiment, the first switch circuit 1331 may perform impedance matching of the fifth antenna 1320 or perform impedance matching of the metal structure 340. For example, when the sixth port P6 and the eighth port P8 of the second switch circuit 1332 are electrically connected, the processor 120 may control the first switch circuit 1331 to perform impedance matching of the fifth antenna 1320 through the second inductor L2, the first capacitor C1, the second capacitor C2, and/or the third capacitor C3. In an embodiment, the impedance matching of the fifth antenna 1320 may be performed in response to a frequency band of an RF signal transmitted/received by the fifth antenna 1320.

For another example, when the sixth port P6 and the seventh port P7 of the second switch circuit 1332 are electrically connected, the first switch circuit 1331 may perform impedance matching of the metal structure 340 by using the first capacitor C1, the second capacitor C2, and/or the third capacitor C3. In an embodiment, the impedance matching of the metal structure 340 may be performed in response to a frequency band (e.g., the first frequency) of an RF signal transmitted/received by the first antenna 411 adjacent to the camera module 320.

According to an embodiment, the second switch circuit 1332 may include a single pole double through (SPDT) switch. However, the second switch circuit 1332 described as a SPIT switch having three ports in FIG. 13 is merely an example, and in an embodiment, the second switch circuit 1332 may include various numbers of ports. For still another example, although the first switch circuit 1331 is described to have five ports in FIG. 13, this is merely an example, and in an embodiment, the first switch circuit 1331 may include various numbers of ports.

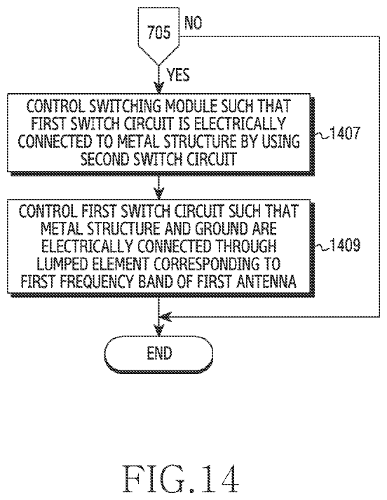

FIG. 14 is a flowchart illustrating an operation of controlling the switching module shown in FIG. 13 by a processor according to an embodiment.

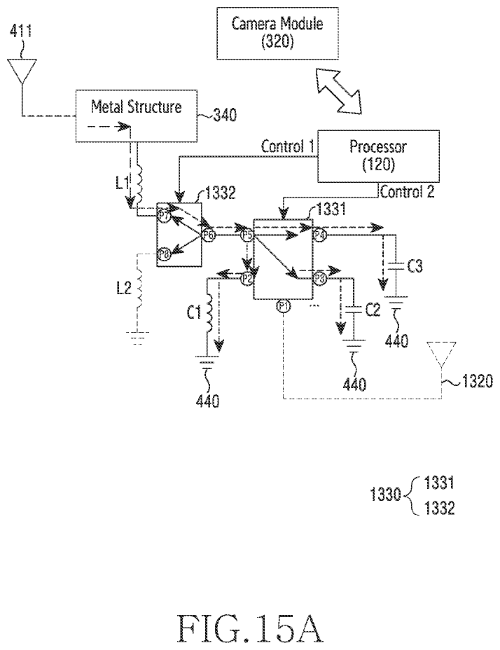

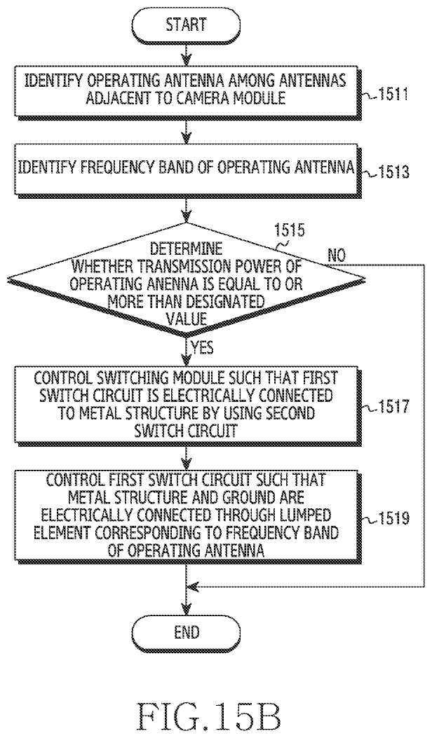

FIG. 15A is a view illustrating an operation in which a processor performs impedance matching of a metal structure by controlling the first switch circuit shown in FIG. 13 according to an embodiment.

Referring to FIG. 14, the processor 120 according to an embodiment may determine whether transmission power of the first antenna 411 is equal to or more than a designated value in operation 705.

According to an embodiment, when transmission power of the first antenna 411 is equal to or more than the designated value, the processor 120 may control the switching module 1330 such that the first switch circuit 1331 is electrically connected to the metal structure by using the second switch circuit 1332 in operation 1407. For example, referring to FIG. 15A, the processor 120 may electrically connect the sixth port P6 and the seventh port P7 of the second switch circuit 1312. In an embodiment, the first switch circuit 1331 may be electrically connected to the metal structure 340 through the first inductor L1.

According to an embodiment, the processor 120 may control the first switch circuit 1331 such that the metal structure 340 and the ground 440 are electrically connected through a lumped element corresponding to the first frequency band of the first antenna 411. For example, referring to FIG. 15A, the processor 120 may control the first switch circuit 1331 such that the metal structure 340 is electrically connected to the ground 440 through the first capacitor C1 corresponding to the first frequency of the first antenna 411 by connecting the third port P3 and the fifth port P5 of the first switch circuit 1331. For another example, the processor 120 may control the first switch circuit 1331 such that the metal structure 340 is electrically connected to the ground 440 through the second capacitor C2. For another example, the processor 120 may control the first switch circuit 1331 such that the metal structure 340 is electrically connected to the ground 440 through the third capacitor C3.

FIG. 15B is a flowchart illustrating an operation of controlling the switching module shown in FIG. 13 by a processor according to an embodiment.

Referring to FIG. 1513, the processor 120 according to an embodiment may identify an operating antenna among antennas (e.g., the first antenna 411 and the third antenna 413) adjacent to the camera module 320 in operation 1511. The operating antenna may be referred to as an antenna transmitting and/or receiving an RF signal to and/or from an external device.

According to an embodiment, the processor 120 may identify a frequency band of the operating antenna in operation 1513. For example, when the first antenna 411 is transmitting and/or receiving an RF signal to and/or from an external device, the processor 120 may identify a first frequency band which is a frequency band of the first antenna 411. For another example, when the second antenna 412 is transmitting and/or receiving an RF signal to and/or from an external device, the processor 120 may identify a second frequency band which is a frequency band of the second antenna 412.

According to an embodiment, the processor 120 may determine whether transmission power of an operating antenna is equal to or more than a designated value in operation 1515. For example, the processor 120 may determine whether power to transmit a first RF signal in a first frequency band is equal to or more than a designated value. For another example, the processor 120 may determine whether power to transmit a second RF signal in a second frequency band is equal to or more than a designated value.

According to an embodiment, when transmission power of the operating antenna is equal to or more than the designated value, the processor 120 may control the switching module 1330 such that the first switch circuit 1331 is electrically connected to the metal structure by using the second switch circuit 1332 in operation 1517.

According to an embodiment, the processor 120 may control the first switch circuit 1331 such that the metal structure 340 and the ground 440 are electrically connected through a lumped element corresponding to a frequency band of the operating antenna in operation 1519. For example, the processor 120 may control the first switch circuit 1331 such that the metal structure 340 and the ground 440 are electrically connected through the first capacitor C1 corresponding to the first frequency band of the first antenna 411. For another example, the processor 1:20 may control the first switch circuit 1331 such that the metal structure 340 and the ground 440 are electrically connected through the second capacitor C2 corresponding to the second frequency band of the third antenna 413.

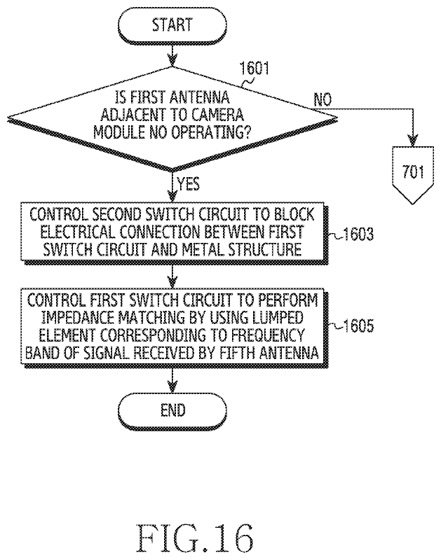

FIG. 16 is a view illustrating an operation in which a processor performs impedance matching of a fifth antenna by using a second switch circuit according to an embodiment.

Referring to FIG. 16, the processor 120 according to an embodiment may determine whether the first antenna 411 adjacent to the camera module 320 operates in operation 1601. For example, the processor 120 may determine whether a RE signal in the first frequency band is transmitted and/or received by using the first antenna 411. In an embodiment, when the first antenna 411 operates, the processor 120 may perform operation 701 shown in FIG. 7.

According to an embodiment, when the first antenna 411 does not operate, the processor 120 may control the second switch circuit 1332 to block electrical connection between the first switch circuit 1331 and the metal structure 340 in operation 1603. For example, referring to FIG. 13, the processor 120 may electrically connect the sixth port P6 and the eighth port P8 of the second switch circuit 1332. In an embodiment, the first switch circuit 1331 may not be electrically connected to the metal structure 340 and may be electrically connected to the ground 440 through the second inductor L2.

According to an embodiment, the processor 120 may control the first switch circuit 1331 to perform impedance matching by using a lumped element corresponding to a frequency band of a signal received by the fifth antenna 1320 in operation 1605. For example, referring to FIG. 13, the processor 120 may perform impedance matching by electrically connecting the first port P1 of the first switch circuit 1331 connected to the fifth antenna 1320 to at least one of the second port P2, the third port P3, the fourth port P4, and/or the fifth port P5.

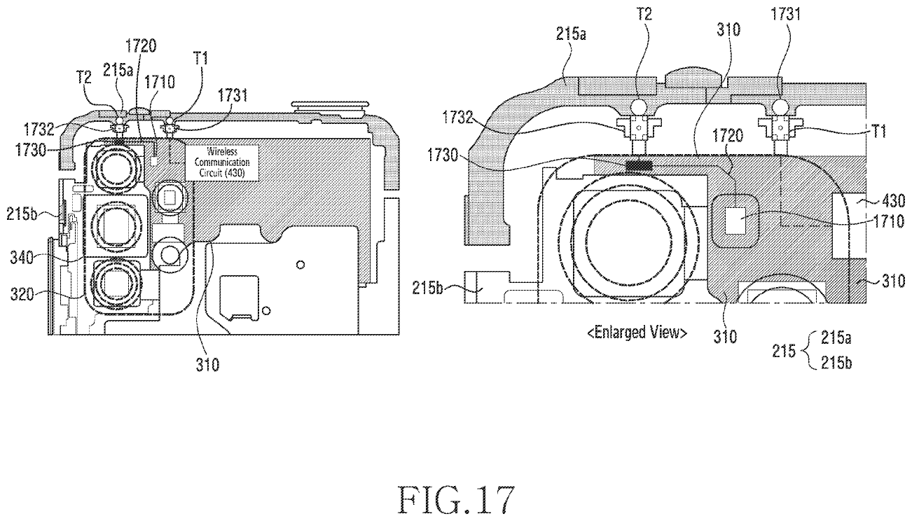

FIG. 17 is an example illustrating an arrangement position of a switching module according to an embodiment.

Referring to FIG. 17, a fifth antenna (e.g., the fifth antenna 1320 in FIG. 13) according to an embodiment may correspond to an inverted-F antenna (IFA). For example, a radiator of the fifth antenna 1320 may include at least a portion of the first frame 215a forming at least a portion of a lateral surface of the electronic device 101. In an embodiment, the wireless communication circuit 420 may receive a signal in a designated frequency band at a first point T1 of the first frame 215a through a first conductive connection member 1731. In an embodiment, the first frame 215a may be electrically connected to a second conductive connection member 1732 at a second point T2 and may be electrically connected to a switching module 1′730 through the second conductive connection member 1732. The switching module 1730 may correspond to the switching module 430 described with reference to FIG. 4. As described with reference to FIG. 4, the switching module 1730 is electrically connected to the ground 440, and as a result, the first frame 215a may be electrically connected to the ground 440 through the second conductive connection member 1732 and the switching module 1730. The ground 440 may be formed on a first layer among multiple layers of the PCB 310. The first conductive connection member 1731 and/or the second conductive connection member 1732 may include, for example, a C-clip or a pogo-pin.

Referring to an enlarged view according to an embodiment, a connection member 1710 (e.g., a gasket, a C-clip, or a pogo-pin) may be disposed at one point of the PCB 310. The connection member 1710 may be in contact with or electrically connected to the metal structure 340. The connection member 1710 may be electrically connected to the switching module 1730 through a conductive path 1720. Accordingly, the metal structure 340 may be electrically connected to the switching module 1730 through the connection member 1710 and the conductive path 1720. In addition, as described above, the switching module 1730 is electrically connected to the ground 440 of the PCB 310, and as a result, the metal structure 340 may be electrically connected to the ground 440 through the connection member 1710, the conductive path 1720, and the switching module 1730.

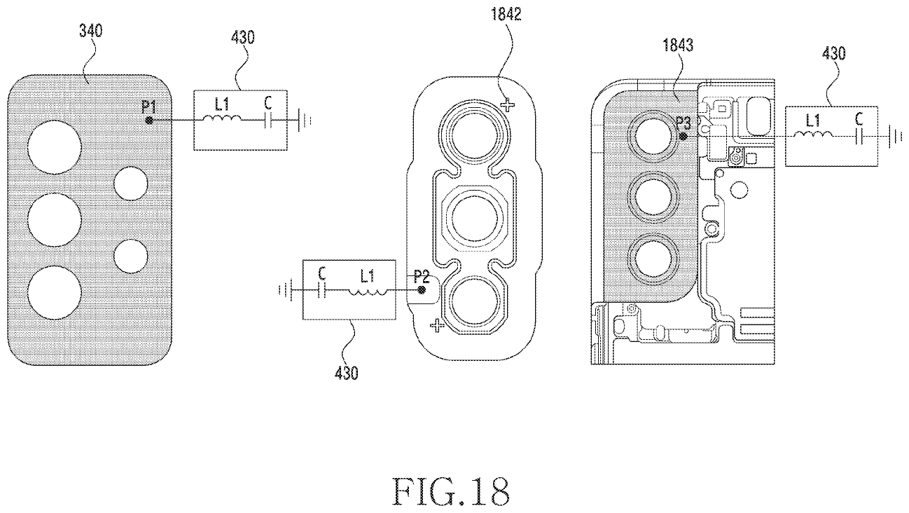

FIG. 18 illustrates a metal structure electrically connected to a switching module according to an embodiment.

Referring to FIG. 18, the switching module 430 according to an embodiment may be electrically connected to various types of metal structures. For example, the first metal structure 340 shown in FIG. 3 may be electrically connected to the switching module 430. In an embodiment, the first metal structure 340 may be electrically connected to the switching module 430 at a first point P1. For another example, a second metal structure 1842 may be electrically connected to the switching module 430. In an embodiment, the second metal structure 1842 may be electrically connected to the switching module 430 at a second point P2. For another example, a third metal structure 1843 may be electrically connected to the switching module 430. In an embodiment, the third metal structure 1843 may be electrically connected to the switching module 430 at a third point P3.

The metal structure shown in FIG. 18 is merely an example and may have various shapes according to a shape of a camera module inside the electronic device 101 or the number of camera and/or a size of a lens included in a camera module in practice.

A point at which the metal structures and the switching module 430 are connected shown in FIG. 18 is merely an example, and the metal structures and the switching module may be connected at various points without limitation to the first point P1, the second point P2, and/or the third point P3.

An electronic device 101 according to various embodiments disclosed herein may include a camera module 320 including at least one camera, a metal structure 340 disposed on and coupled to the camera module 320 to cover a portion of the camera module 320, a first antenna 411 adjacent to the camera module 320, a second antenna 412 spaced a designated distance or more apart from the camera module 320, a switching module 430 electrically connected to the metal structure 340, including at least one lumped element, and adjusting an impedance, by using the at least one lumped element, a ground 440 electrically connected to the metal structure 340 through the switching module 430, and at least one processor 120 electrically connected to the first antenna 411, the second antenna 412, and the switching module 430. The at least one processor 120 may transmit a signal in a first frequency band by feeding the first antenna 411 adjacent to the camera module 320, determine whether transmission power of the first antenna 411 is equal to or more than a designated value when the first frequency band corresponds to a designated frequency band, and control the switching module 430 such that the switching module 430 has a first impedance corresponding to the first frequency band and electrically connects the metal structure 340 and the ground 440 when the transmission power of the first antenna 411 is equal to or more than the designated value.

According to an embodiment, the switching module may include a variable capacitor, and the at least one processor may control the variable capacitor such that the switching module has the first impedance corresponding to the first frequency band.

According to an embodiment, the switching module may include a first lumped element and a second lumped element electrically connected to a ground, and a switch electrically connected to the metal structure, and the at least one processor may control the switch such that the metal structure is electrically connected to the ground through the first lumped element or the second lumped element.

According to an embodiment, the switch may correspond to a single pole double through (SPDT) switch.

The electronic device according to an embodiment may further include a memory configured to store information on the first impedance corresponding to the first frequency hand and the at least one processor may obtain information on the first impedance from the memory.

The electronic device according to an embodiment may further include a third antenna adjacent to the camera module, and the at least one processor may transmit a signal in a second frequency band by feeding the third antenna adjacent to the camera module, determine whether transmission power of the third antenna is equal to or more than a designated value when the second frequency band corresponds to the designated frequency band, and control the switching module such that the switching module has a second impedance corresponding to the second frequency band and electrically connects the metal structure and the ground when transmission power of the third antenna is equal to or more than the designated value.

The electronic device according to an embodiment may further include a printed circuit board (PCB), the PCB may include a first surface facing a rear surface of the electronic device, and the camera module may be disposed on the first surface of the PCB.

According to an embodiment, the PCB may include multiple conductive layers, and the ground may be formed on a first layer among the multiple conductive layers.

The electronic device according to an embodiment may further include a third antenna electrically connected to the switching module and configured to receive a signal in a second frequency band, and the at least one processor may control the switching module such that the switching module has a second impedance corresponding to the second frequency band when a signal in the second frequency band is received via the third antenna.

According to an embodiment, the at least one camera of the camera module may face a first direction perpendicular to the rear surface of the electronic device.

According to an embodiment, the camera module may obtain image data, and the obtained image data may be transmitted to the at least one processor electrically connected to the camera module.

The electronic device according to an embodiment may further include a frame configured to form at least a portion of a lateral surface of the electronic device, and the first antenna may correspond to a conductive portion of the frame adjacent to the camera module.

According to an embodiment, the signal in the first frequency band may correspond to a reference signal for measurement of a channel quality of a wireless communication channel based on the first frequency band.

The electronic device according to an embodiment may further include a memory configured to store information on the designated frequency band.

The electronic device according to an embodiment may further include a support member configured to fix the camera module.

An electronic device 101 according to various embodiments disclosed herein may include a frame 215 configured to form at least a portion of an edge of the electronic device 101, a camera module 320 disposed adjacent to a first corner and including at least one camera, a metal structure 340 disposed on and coupled to the camera module 320 to cover a portion of the camera module 320, a switching module 430 electrically connected to the metal structure 340, including at least one lumped element, and configured to adjust an impedance by using the at least one lumped element, a ground 440 electrically connected to the metal structure 340 through the switching module 430, and at least one processor 120 electrically connected to the switching module 430. The edge of the electronic device 101 formed by the frame 215 may include a first edge 301 extending toward a first direction and a second edge 302 configured to form a first corner at one end of the first edge 301 and extending in a second direction perpendicular to the first direction. The frame 215 may include a first portion configured to form an area including the first corner. The at least one processor 120 may transmit a signal in a first frequency band by feeding the first portion of the frame 215, determine whether transmission power of the signal in the first frequency band is equal to or more than a designated value when the first frequency band corresponds to a designated frequency band, and control the switching module 430 such that the switching module 430 has a first impedance corresponding to the first frequency band and electrically connects the metal structure 340 and the ground 440.

In the electronic device according to an embodiment, the switching module may include a variable capacitor, and the at least one processor may control the variable capacitor such that the switching module has a first impedance corresponding to a first frequency band.

The switching module according to an embodiment may include a first lumped element and a second lumped element electrically connected to the ground, and a switch electrically connected to the metal structure, and the at least one processor may control the switch such that the metal structure is electrically connected to the ground through the first lumped element or the second lumped element.

The electronic device according to an embodiment may further include a memory configured to store information on the first impedance corresponding to the first frequency band and the at least one processor may obtain information on the first impedance from the memory.

According to an embodiment, the camera module may obtain image data, and the obtained image data may be transmitted to the at least one processor electrically connected to the camera module.

What is claimed is:

1. Art electronic device comprising:
a camera module comprising at least one camera;
a metal structure disposed on and coupled to the camera module to cover a portion of the camera module;
a first antenna adjacent to the camera module and a second antenna spaced apart from the camera module;
a switching module electrically connected to the metal structure and comprising at least one lumped element;
a ground electrically connected to the metal structure through the switching module; and
at least one processor electrically connected to the first antenna, the second antenna, and the switching module,
wherein the at least one processor is configured to:
transmit a signal in a first frequency band by feeding the first antenna adjacent to the camera module,
determine whether transmission power of the first antenna is equal to or more than a designated value when the first frequency band corresponds to a designated frequency hand, and
control the switching module such that the switching module has a first impedance corresponding to the first frequency band and electrically connects the metal structure and the ground when the transmission power of the first antenna is equal to or more than the designated value.

2. The electronic device of claim 1,
wherein the switching module comprises a variable capacitor, and
wherein the at least one processor is configured to control the variable capacitor such that the switching module has the first impedance corresponding to the first frequency band.

3. The electronic device of claim 1,
wherein the switching module comprises:
a first lumped element and a second lumped element, the first lumped element and the second lumped element being electrically connected to the ground, and
a switch electrically connected to the metal structure,
wherein the at least one processor is configured to control the switch such that the metal structure is electrically connected to the ground through the first lumped element or the second lumped element.

4. The electronic device of claim 3,
wherein the switch corresponds to a single pole double through (SPDT) switch.

5. The electronic device of claim 1, further comprising
a memory configured to store information on the first impedance corresponding to the first frequency hand,
wherein the at least one processor obtains information on the first impedance from the memory.

6. The electronic device of claim 1, further comprising
a third antenna adjacent to the camera module,
wherein the at least one processor is configured to:
transmit a signal in a second frequency band by feeding the third antenna adjacent to the camera module,
determine whether transmission power of the third antenna is equal to or more than the designated value when the second frequency band corresponds to the designated frequency band, and
control the switching module such that the switching module has a second impedance corresponding to the second frequency band and electrically connects the metal structure and the ground when transmission power of the third antenna is equal to or more than the designated value.

7. The electronic device of claim 1, further comprising
a printed circuit board (PCB),
wherein the PCB comprises a first surface facing a rear surface of the electronic device, and
wherein the camera module is disposed on the first surface of the PCB.

8. The electronic device of claim 7,
wherein the PCB comprises multiple conductive layers, and
wherein the ground is formed on a first layer among the multiple conductive layers.

9. The electronic device of claim 1, further comprising
a third antenna electrically connected to the switching module and configured to receive a signal in a second frequency band,
wherein the at least one processor is configured to:
control the switching module such that the switching module has a second impedance corresponding to the second frequency band when a signal in the second frequency band is received via the third antenna.

10. The electronic device of claim 1,
wherein the at least one camera of the camera module faces a first direction perpendicular to the rear surface of the electronic device.

11. The electronic device of claim 1,
wherein the camera module is configured to obtain image data, and
wherein the obtained image data is transmitted to the at least one processor electrically connected to the camera module.

12. The electronic device of claim 1, further comprising
a frame forming at least a portion of a lateral surface of the electronic device,
wherein the first antenna corresponds to a conductive portion of the frame adjacent to the camera module.

13. The electronic device of claim 1,
wherein the signal in the first frequency band corresponds to a reference signal for measurement of a channel quality of a wireless communication channel based on the first frequency band.

14. The electronic device of claim 1, further comprising
a memory configured to store information on the designated frequency band.

15. The electronic device of claim 1, further comprising
a support member configured to fix the camera module.

16. An electronic device comprising:
a frame forming at least a portion of an edge of the electronic device, the edge comprising a first edge extending toward a first direction and a second edge forming a first corner at one end of the first edge and extending in a second direction perpendicular to the first direction, the frame comprising a first portion forming an area comprising the first corner;
a camera module disposed adjacent to the first corner, the camera module comprising at least one camera;
a metal structure disposed on and coupled to the camera module to cover a portion of the camera module;
a switching module electrically connected to the metal structure and comprising at least one lumped element;
a ground electrically connected to the metal structure through the switching module; and
at least one processor electrically connected to the switching module,
wherein the at least one processor is configured to:
transmit a signal in a first frequency band by feeding the first portion of the frame,
determine whether transmission power of the signal in the first frequency band is equal to or more than a designated value when the first frequency band corresponds to a designated frequency band, and
control the switching module such that the switching module has a first impedance corresponding to the first frequency hand and electrically connects the metal structure and the ground when the transmission power is equal to or more than the designated value.

17. The electronic device of claim 16,
wherein the switching module comprises a variable capacitor, and
wherein the at least one processor controls the variable capacitor such that the switching module has the first impedance corresponding to the first frequency band.

18. The electronic device of claim 16,
wherein the switching module comprises:
a first lumped element and a second lumped element electrically connected to the ground, and
a switch electrically connected to the metal structure,
wherein the at least one processor is configured to control the switch such that the metal structure is electrically connected to the ground through the first lumped element or the second lumped element.

19. The electronic device of claim 16, further comprising
a memory configured to store information on the first impedance corresponding to the first frequency band,
wherein the at least one processor is configured to obtain information on the first impedance from the memory.

20. The electronic device of claim 16,
wherein the camera module is configured to obtain image data, and
wherein the obtained image data is transmitted to the at least one processor electrically connected to the camera module.
